(19) United States
(12) Patent Application Publication
(10) Pub. No.: US 2015/0340768 A1
(43) Pub. Date: Nov. 26, 2015

(54) WIDEBAND AND HIGH GAIN OMNIDIRECTIONAL ARRAY ANTENNA

(71) Applicants: Donald L. Rucker, Sacramento, CA (US); Phillip Nash, Dayton, OH (US); Ronald M. Westberg, Temecula, CA (US)

(72) Inventors: Donald L. Rucker, Sacramento, CA (US); Phillip Nash, Dayton, OH (US); Ronald M. Westberg, Temecula, CA (US)

(21) Appl. No.: 14/720,686

(22) Filed: May 22, 2015

Related U.S. Application Data
(60) Provisional application No. 62/002,516, filed on May 23, 2014.

(51) Int. Cl. H01Q 21/00; H01Q 1/38

(52) U.S. Cl. CPC H01Q 21/00; H01Q 1/38

(57) ABSTRACT

Systems and methods relating to antennas for transmission and reception of radio frequency communications. More particularly, implementations of the present invention relate to a high gain two element omnidirectional array, which through the employment of a combination balun/power divider and precise coaxial engagement to the antenna, converts the unbalanced coaxial transmission line voltage into a pair of balanced transmissions connecting with four radiating gaps.

### RELATED APPLICATIONS

This application claims priority to U.S. Provisional Patent Application Ser. No. 62/002,516 (Attorney Docket No. 11072.730) filed May 23, 2014, entitled WIDEBAND HIGH GAIN OMNIDIRECTIONAL ARRAY ANTENNA, which is incorporated herein by reference in its entirety.

### BACKGROUND OF THE INVENTION

1. Field of the Invention

The present invention relates to antennas for transmission and reception of radio frequency communications. More particularly, implementations of the present invention relate to a high gain two element omnidirectional array, which through the employment of a combination balun/power divider and precise coaxial engagement to the antenna, converts the unbalanced coaxial transmission line voltage into a pair of balanced transmissions connecting with four radiating gaps.

2. Background and Related Art

Antennas provide electronic communication for radios, televisions, and cellular and smart telephones, as well as other electronic devices. With the advent of streaming media and broadcast media in high definition on hundreds of channels, the need for antennas capable of broadcast and reception across a wideband of frequencies to provide a pathway to communicate RF signals for media and other communications to homes and businesses is becoming more urgent since conventional antennas for the purpose are not up to the task, having been designed for other uses in prior years.

Array antennas have been employed for communication of RF broadcasts. However, conventional omnidirectional arrays require two radiating elements and a power divider and multiple wired connections between multiple layers forming the conventional array and have yielded antennas with too much loss. Further, because conventional arrays are constructed three-dimensional in multiple layers which require interconnecting wires carrying the signal, a lot of variability in performance occurs. Such is due to the complex structure with multiple layers of circuit boards and interconnecting cables and power dividers. Further, such conventional construction for three-dimensional arrays is expensive to manufacture and by including multiple layers and parts which must be interconnected, such construction frequently leads to antennas broadcasting the RF signal out of phase.

Thus, while techniques are currently available, challenges exist. Accordingly, it would be an improvement in the art to augment or even replace current techniques with other techniques.

### SUMMARY OF THE INVENTION

The present invention relates to antennas for transmission and reception of radio frequency communications. More particularly, implementations of the present invention relate to a high gain two element omnidirectional array, which through the employment of a combination balun/power divider and precise coaxial engagement to the antenna, converts the unbalanced coaxial transmission line voltage into a pair of balanced transmissions connecting with four radiating gaps.

Implementations of the present invention embrace a construction for an array antenna for broadcast and reception of RF communications. In at least some implementations, such an antenna is formed on a single layer of dielectric material to reduce complexity and cost of manufacturing as well as to increase durability. Such a device, configured in this single layer construction is adapted to receive the unbalanced coaxial transmission line voltages and convert them to communicate along balanced transmission lines which connect to multiple radiating gaps formed on the single layer antenna. Such an array formed in such a manner is configured to communicate the broadcast signal to onboard wideband radiating antenna structures or elements in phase.

Implementations of the device and method herein disclosed and described provide a solution to the shortcomings in prior art in RF antenna arrays for the broadcast and reception of RF signals using electric signals carried for communication to and from a plurality of antenna radiating elements using a single coaxial cable engaged thereto.

Unlike prior art of array antennas which uses multiple layers in a three-dimensional configuration, the device herein is formed on opposing sides of a signal planar dielectric substrate using conductive material such as copper or other conductive metals strategically placed thereon. The conductive material is positioned on the substrate in a manner to form four individual radiating areas of the conductive material. Additionally, a combination balun/power divider is formed and operatively positioned to convert any unbalanced coaxial transmission line voltages communicated from engaged coaxial cable along two balanced transmission lines. The two balanced transmission lines are connected in an operative engagement to four radiating gaps which in turn communicate the RF signal in phase to the wideband radiating structures formed of conductive material on the substrate of a dielectric material.

The resulting antenna array formed on a single substrate provides higher gain than conventional multi component two element omnidirectional arrays. In the device, an array balance point is located at coaxial transmission line output communication with the array. So engaged, as noted, the array is structured such that the electronic signal communicated from the coaxial cable, arrives in phase at all of four radiating gaps.

This results in an antenna array with higher performance than conventional array antennas and one which is formed on single planar substrate thereby also reducing manufacturing complexity and costs.

With respect to the above description, before explaining at least one preferred embodiment of the herein disclosed antenna invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other antenna structures, and methods and systems for carrying out the several purposes of the present disclosed device. It is important, therefore, that the claims be regarded as including such equivalent construction and methodology insofar as they do not depart from the spirit and scope of the present invention.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 depicts a perspective view of a first side surface of the formed array shown with coaxial transmission line engaged and a protective cover removed;

FIG. 2 depicts a top plan view of the first side surface device herein having a slightly different configuration from FIG. 1, and shows the formation of the feed line with a solid core in a length “L” determined as optimum for mounting of the array above a surface.

FIG. 3 shows a top plan view of a second side surface of the disclosed array device formed to mirror and register with that of the conductive material of FIG. 3;

FIG. 4 is a top plan view of the first side surface of the array of FIG. 1, showing the engagement of the coaxial feedline to the conductive surface areas of the first surface;

FIG. 5 depicts the second side surface opposite that of FIG. 4, and in a mirrored image thereof and engaged within a plastic housing which is shown as transparent on side surfaces; and

FIG. 6 shows the second side surface in a view opposite that of FIG. 5 and showing the device of FIG. 4 housed within the plastic housing in an as-used position.

### DETAILED DESCRIPTION OF THE INVENTION

The present invention relates to antennas for transmission and reception of radio frequency communications. More particularly, implementations of the present invention relate to a high gain two element omnidirectional array, which through the employment of a combination balun/power divider and precise coaxial engagement to the antenna, converts the unbalanced coaxial transmission line voltage into a pair of balanced transmissions connecting with four radiating gaps.

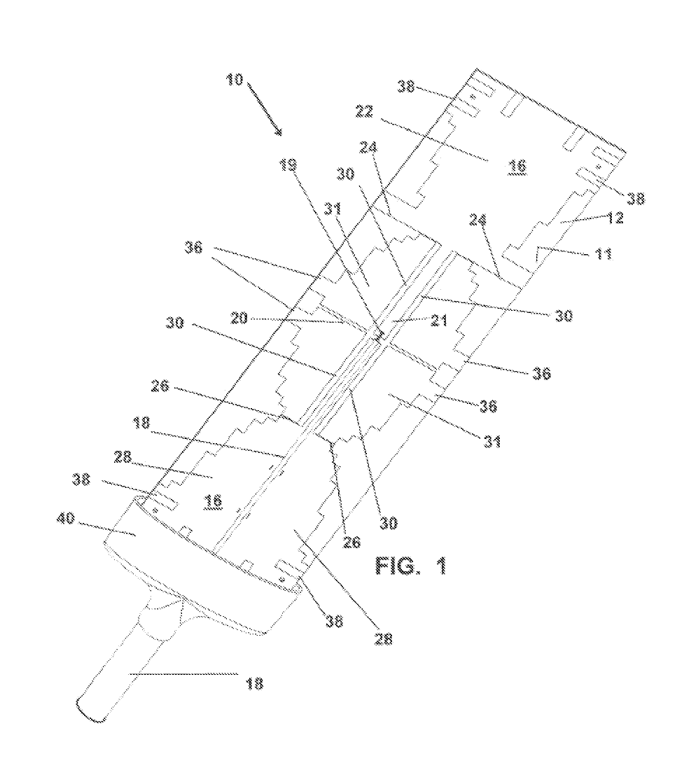

Now referring to drawings in FIGS. 1-6, wherein similar components are identified by like reference numerals, there is seen in FIG. 1 a perspective view of a first side surface 11 of the formed array device 10 herein which is on the opposite side of a planar dielectric substrate 12 from the second side surface 14 shown in FIGS. 3-5. The first surface 11 has conductive material 16 positioned thereon which is placed in a registered positioning with the conductive material 16 on the second side surface 14 to form an operative engagement therebetween.

Shown in FIG. 1 is the feedline 18 which is a coaxial cable terminating at a distal end at an attachment of the center conductor 19 which communicates across an isolation slot 20 to a soldered engagement 21 with the conductive material 16 communicating from an upper half 22 of the device 10 herein. Also shown are an upper feed gap 24 which is positioned to allow radiation from the upper half 22, and a second or lower feed gap 26 positioned to allow radiation from the lower half 28 of the antenna device 10 herein. Gaps 30 are positioned within a central portion 31 formed of conductive material 16 and sized for impedance control.

The conductive material 16 forming the plated areas on this first side surface 11 of the dielectric substrate 12 which is formed in a planar rigid configuration such as with a circuit board, to maintain the positioning of the conductive material 16 thereon.

Side edges of the conductive material 16 forming the upper half 22, lower half 28, and central portion 31 have a stepped configuration. Four isolation tabs 36 extend along the side edges of the conductive material of the central portion 31.

Also shown are choke slots 38 formed along the side edges to prevent current from conflicting with radiation emitted from the upper feed gaps 24 and the lower feed gaps 26.

The second side surface 14 of the dielectric substrate 12 as noted above and shown in FIGS. 3-6, has the conducting material 16 positioned thereon substantially in a mirror image of that of the first side surface 11 and in a position to register with the edges of the conductive material 16 on the first side surface 11. So configured, the disclosed antenna device 10 provides 360 degrees Azimuth, and 30 degrees elevation coverage in vertical polarization with approximately 5 dBi gain. The gain variation around azimuth is ±1 dB or less.

The antenna device 10 as depicted provides a low cost solution for the construction of a wide band omnidirectional antenna with high gain and in-phase transmission. This low cost and significant increase in performance is enabled by the construction employing a simple printed circuit of conductive material 16 on both sides of a suitable dielectric substrate 12 with no via holes required. The antenna is configured for performance in a wide frequency range such as 470 MHz to 700 MHz, or other similar bands depending on the size of the printed circuit forming the conductive material 16.

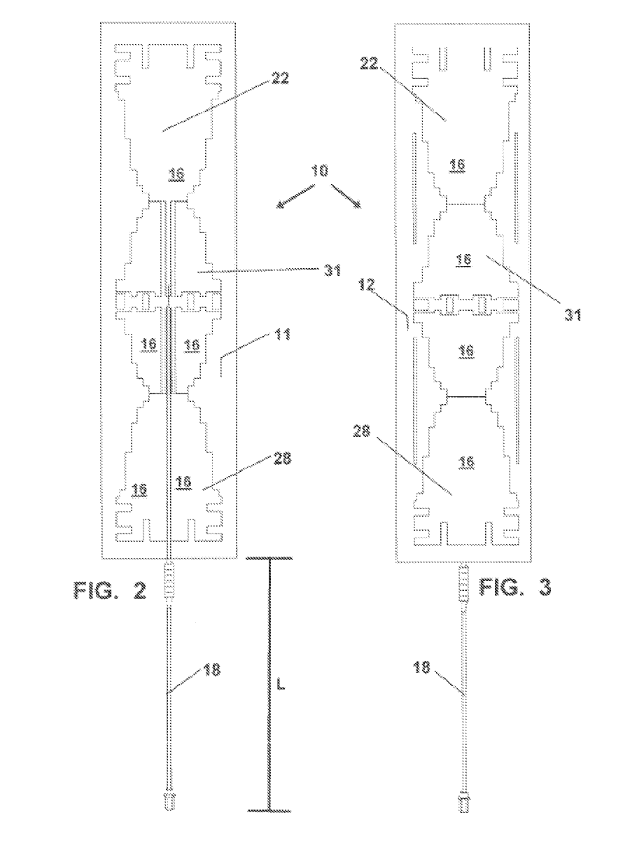

FIG. 2 as noted depicts a top plan view of a first side surface 11 of the antenna device 10 in a slightly different configuration of the conductive material 16 from that of FIG. 1 and shows the formation of the feedline 18 with a solid exterior core to provide a rigid support for the antenna device 10 in the as-used position in a length “L” determined as optimum distance for mounting of the array above a surface. FIG. 3 depicts the second side surface 12 of the device 10 of FIG. 2 showing the mirrored areas of conductive material 16 thereon.

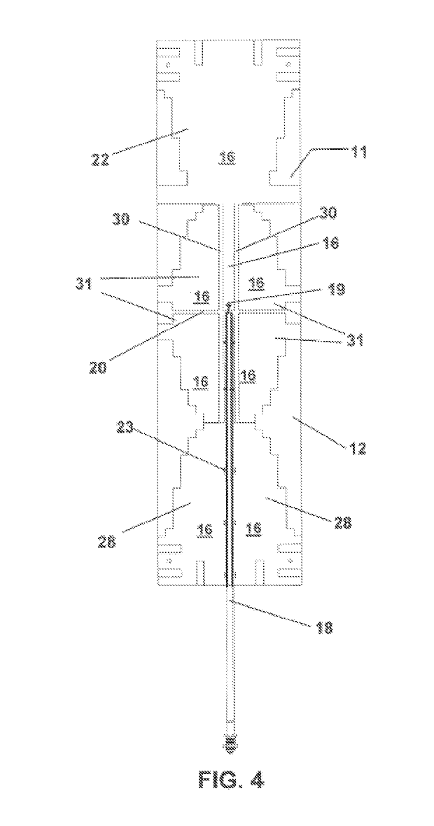

FIG. 4 is a top plan view of the first side surface 11 of the antenna device 10 in a form of FIG. 1, showing the circuit board forming the dielectric material substrate 12 and showing the soldered engagement 19 of the center wire of the coaxial feedline 18 to the conductive surface 16 extending between the gaps 30 and communicating with the upper half 22. Also shown is the soldered engagement 23 of the exterior of the feedline 18 with the conductive material forming the lower half 28.

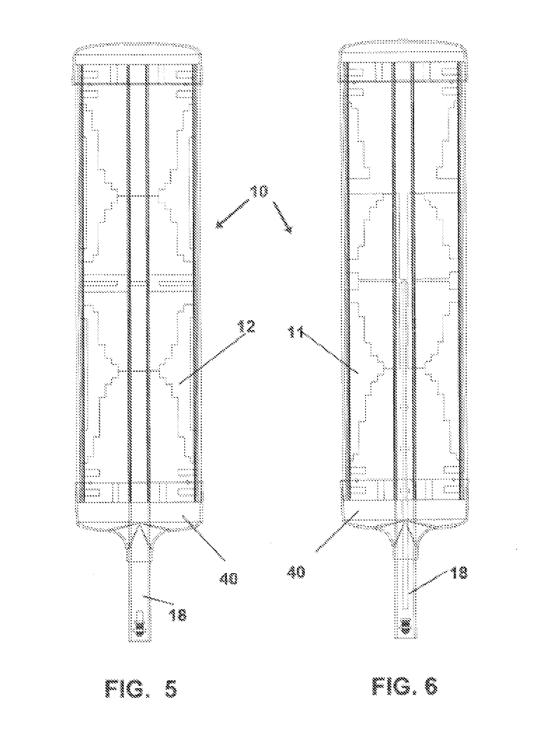

FIGS. 5 and 6 show the two opposite sides of the disclosed device 10 in typical fashion for all formations, and shows their positioning in an as-used position, within a plastic protective housing 40 to protect the device from weather and the elements.

While all of the fundamental characteristics and features of the antenna device 10 forming an array on a single layer of a dielectric substrate herein have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

Thus, as discussed herein, embodiments of the present invention embrace antennas for transmission and reception of radio frequency communications. More particularly, implementations of the present invention relate to a high gain two element omnidirectional array, which through the employment of a combination balun/power divider and precise coaxial engagement to the antenna, converts the unbalanced coaxial transmission line voltage into a pair of balanced transmissions connecting with four radiating gaps.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An antenna array formed as a unitary structure on a single layer of a dielectric substrate.
